(19) United States
(12) Patent Application Publication
(10) Pub. No.: US 2013/0103953 A1
(43) Pub. Date: Apr. 25, 2013

(54) APPARATUS AND METHOD FOR ENCRYPTING HARD DISK

(71) Applicants: Jeong-Seok LIM, Daejeon (KR); Bon-Seok KOO, Daejeon (KR); Soo-Hyeon KIM, Daejeon (KR); Hyo-Won KIM, Daejeon (KR); Jung-Hyung PARK, Daejeon (KR); Kwang-Mo YANG, Daejeon (KR); Jae-Woo HAN, Daejeon (KR); Choon-Soo KIM, Daejeon (KR); E-Joong YOON, Daejeon (KR)

(72) Inventors: Jeong-Seok LIM, Daejeon (KR); Bon-Seok KOO, Daejeon (KR); Soo-Hyeon KIM, Daejeon (KR); Hyo-Won KIM, Daejeon (KR); Jung-Hyung PARK, Daejeon (KR); Kwang-Mo YANG, Daejeon (KR); Jae-Woo HAN, Daejeon (KR); Choon-Soo KIM, Daejeon (KR); E-Joong YOON, Daejeon (KR)

(73) Assignee: ELECTRONICS AND TELECOMMUNICATIONS RESEARCH INSTITUTE, Daejeon (KR)

(21) Appl. No.: 13/325,915

(22) Filed: Dec. 14, 2011

(30) Foreign Application Priority Data
Oct. 24, 2011 (KR) 10-2011-0109006

(51) Int. Cl. H04L 9/28

(52) U.S. Cl. 713/189

(57) ABSTRACT

An apparatus and method for encrypting a hard disk are provided. The apparatus includes a program management unit, an Internet Protocol (IP) management unit, and an encryption processing unit. The program management unit causes an allowed program or process to be executed based on a result of determination as to whether the program or process to be executed in a host terminal is allowed to gain access. The IP management unit causes data to be transmitted to an allowed destination IP address based on a result of determination as to whether the destination IP address to which the host terminal attempts to transmit the data is allowed to be accessed. The encryption processing unit encrypts and decrypts all data, exchanged between the host terminal and the hard disk by applying an algorithm, selected by a user, to the data.

### CROSS REFERENCE TO RELATED APPLICATION

This application claims the benefit of Korean Patent Application No. 10-2011-0109006, filed on Oct. 24, 2011, which is hereby incorporated by reference in its entirety into this application.

### BACKGROUND OF THE INVENTION

1. Technical Field

The present invention relates generally to an apparatus and method for encrypting a hard disk and, more particularly, to an apparatus and method for encrypting a hard disk, which determine the accessibility of a variety of types of hard disks, added to a host terminal, between the host terminal and the hard disk, and perform encryption and decryption, thereby preventing the illegitimate leakage of data.

2. Description of the Related Art

In a recent network-oriented architecture, computers are connected to the Internet or intranets and then exchange information, rather than being installed and used independently. In this case, important data created by users are chiefly stored in hard disks.

However, when computers are connected to an open environment such as the Internet, there are always risks, such as the illegitimate leakage of important data attributable to illegitimate access to data by a third person and the leakage of data attributable to infection with malicious code. In order to overcome these risks, there is a need for a method of protecting data stored in the hard disks of computers. The most efficient method is to employ an encryption technology.

Self-Encrypting Disk (SED), which is one of such encryption technologies, is an encryption technology which is used to protect user data stored in the hard disks of computers.

In accordance with SED, data stored in a hard disk is always kept encrypted, and a user can selectively and freely turn on and off encryption functionality. Meanwhile, when a situation, such as the emergent discard of a hard disk, occurs, the disk can be erased in terms of cryptography by changing an encryption key which was used to encrypt data.

SED employs a disk encryption key and an authentication key for controlling access to a disk for directly encrypting data. Here, the hash value of the authentication key is stored in a hard disk, is used to authenticate a user and is used to decrypt the disk encryption key after the user has been successfully authenticated.

SED is problematic in that a user cannot freely select a hard disk and cannot freely replace a fixed encryption algorithm used to encrypt data because SED was developed to be installed on a specific hard disk in the form of a single chip and to form a package along with the specific hard disk.

### SUMMARY OF THE INVENTION

Accordingly, the present invention has been made keeping in mind the above problems occurring in the prior art, and an object of the present invention is to provide an apparatus and method for encrypting a hard disk, which determine the accessibility of a variety of types of hard disks, added to a host terminal, between the host terminal and the hard disk, and perform encryption and decryption, thereby preventing the illegitimate leakage of data

In order to accomplish the above object, the present invention provides an apparatus for encrypting a hard disk, including a program management unit for causing an allowed program and process to be executed based on a result of determination as to whether the program and process to be executed in a host terminal is allowed to gain access; an Internet Protocol (IP) management unit for causing data to be transmitted to an allowed destination IP address based on a result of determination as to whether the destination IP address to which the host terminal attempts to transmit the data is allowed to be accessed; and an encryption processing unit for encrypting and decrypting all data, exchanged between the host terminal and the hard disk, by applying an algorithm, selected by a user, to the data.

The apparatus may further include a host matching unit for operating selectively in conjunction with an interface of the hard disk which is connected to the host terminal; wherein the host matching unit, when the user transfers a write command via the host terminal, transfers data, input in response to the write command, to the encryption processing unit, so that it is encrypted, and, when the user transfers a read command via the host terminal, transfers data, decrypted by the encryption processing unit, to the host terminal.

The apparatus may further include a hard disk matching unit for operating selectively in conjunction with the interface of the hard disk which is connected to the host terminal; the hard disk matching unit, when the user transfers the write command via the host terminal, transferring the data, input in response to the write command and encrypted by the encryption processing unit, to the hard disk, and, when the user transfers the read command via the host terminal, receiving encrypted data stored in the hard disk and transferring the received encrypted data to the encryption processing unit.

When the user transfers the write command via the host terminal, the encryption processing unit may receive the data input in response to the write command and transferred via the host matching unit, and create the encrypted data by applying the algorithm, selected by the user, to the input data.

The encryption processing unit may transfer the encrypted data to the hard disk via the hard disk matching unit.

When the user transfers the read command via the host terminal, the encryption processing unit may receive the encrypted data transferred from the hard disk via the hard disk matching unit, and create the decrypted data by applying an algorithm, selected by the user, to the encrypted data.

The encryption processing unit may transfer the decrypted data to the host terminal via the host matching unit.

The program management unit may create access registration information; that is, information about accessible programs and processes, by checking a list of programs and processes installed in the host terminal; and, when a new program or process is to be executed in the host terminal, determine whether to allow it to be executed by determining whether the new program or process exists in the access registration information.

The IP management unit may create IP registration information by checking information about IP addresses which have been accessed by programs and processes installed in the host terminal; and, when the host terminal is connected to a program or process network and data is transferred to a destination IP address, determine whether to transmit the data by determining whether the destination IP address exists in the IP registration information.

In order to accomplish the above object, the present invention provides a method of encrypting a hard disk, including determining whether a user has mounted an authentication module into an authentication module connection unit; determining whether user authentication information of the authentication module is identical to previously stored user authentication information; if the user authentication information of the authentication module is identical to the previously stored user authentication information, causing an allowed program and process to be executed based on a result of determination as to whether the program and process to be executed in a host terminal is allowed to gain access; causing data to be transmitted to an allowed destination IP address based on a result of determination as to whether the destination IP address to which the host terminal attempts to transmit the data is allowed to be accessed; and encrypting and decrypting all data exchanged between the host terminal and the hard disk, by applying an algorithm, selected by a user, to the data.

The causing an allowed program and process to be executed may include creating access registration information, that is, information about accessible programs and processes, by checking a list of programs and processes installed in the host terminal; and, when a new program or process is to be executed in the host terminal, determining whether to allow it to be executed by determining whether the new program or process exists in the access registration information.

The causing data to be transmitted to an allowed destination IP address may include creating IP registration information by checking information about IP addresses which have been accessed by programs and processes installed in the host terminal; and, when the host terminal is connected to a program or process network and data is transferred to a destination IP address, determining whether to transmit the data by determining whether the destination IP address exists in the IP registration information.

The encrypting and decrypting may include, when the user transfers a write command via the host terminal, receiving data input in response to the write command and transferred via a host matching unit; creating encrypted data by applying the algorithm, selected by the user, to the input data and transferring the encrypted data to the hard disk via a hard disk matching unit.

The encrypting and decrypting may include, when the user transfers a read command via the host terminal, receiving encrypted data from the hard disk via a hard disk matching unit; creating decrypted data by applying the algorithm, selected by the user, to the encrypted data; and transferring the decrypted data to the host terminal via a host matching unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating an apparatus for encrypting a hard disk according to an embodiment of the present invention;

FIG. 2 is a diagram schematically illustrating an example of the appearance of the apparatus for encrypting a hard disk shown in FIG. 1;

FIG. 3 is a flowchart illustrating a process in which the program management unit of the apparatus for encrypting a hard disk shown in FIG. 1 controls access so as to prevent the illegitimate leakage of data;

FIG. 4 is a flowchart illustrating a process in which the IP management unit of the apparatus for encrypting a hard disk shown in FIG. 1 controls access so as to prevent the illegitimate leakage of data; and

FIG. 5 is a flowchart illustrating a process in which the apparatus for encrypting a hard disk performs encryption and decryption according to an embodiment of the present invention.

### DESCRIPTION OF THE PREFERRED EMBODIMENTS

Reference now should be made to the drawings, throughout which the same reference numerals are used to designate the same or similar components.

The present invention will be described in detail below with reference to the accompanying drawings. Repetitive descriptions and descriptions of known functions and constructions which have been deemed to make the gist of the present invention unnecessarily vague will be omitted below. The embodiments of the present invention are provided in order to fully describe the present invention to a person having ordinary skill in the art. Accordingly, the shapes, sizes, etc. of elements in the drawings may be exaggerated to make the description clear.

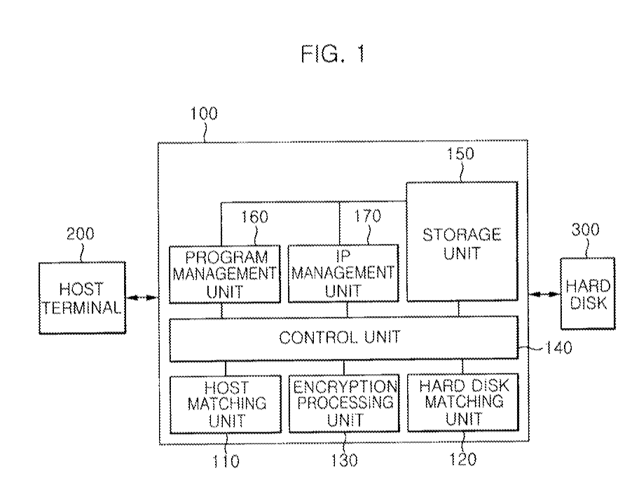

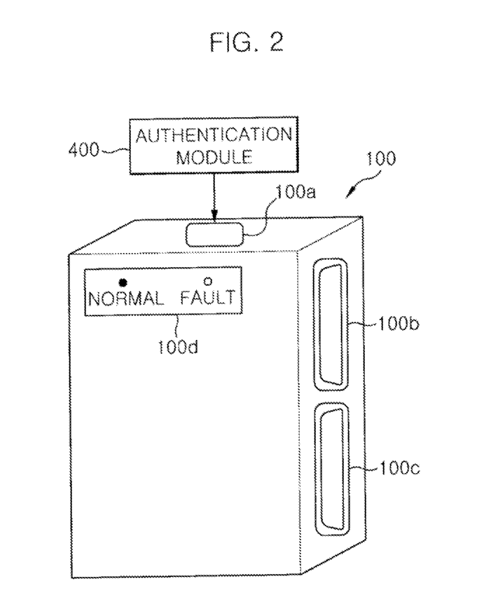

FIG. 1 is a diagram schematically illustrating an apparatus 100 for encrypting a hard disk according to an embodiment of the present invention. FIG. 2 is a diagram schematically illustrating an example of the appearance of the apparatus 100 for encrypting a hard disk shown in FIG. 1.

As illustrated in FIG. 1, the apparatus 100 for encrypting a hard disk according to the embodiment of the present invention is interposed between a host terminal 200 and a hard disk 300, and automatically encrypts and decrypts data accessed by previously registered legitimate programs and processes without requiring intervention of a user. The hard disk 300 according to an embodiment of the present invention may include a Universal Serial Bus (USB) hard disk, a Serial Advanced Technology Attachment (SATA) hard disk, an Integrated Drive Electronics (IDE) hard disk, etc.

The example of the appearance of the apparatus 100 for encrypting a hard disk is conceptually divided into an authentication module connection unit 100a, a host connection unit 100b, a hard disk connection unit 100c, and a status display unit 100d, as illustrated in FIG. 2.

The authentication module connection unit 100a is configured such that an authentication module 400 to be inserted to perform authentication can be mounted thereinto. Here, the authentication module 400 is a dongle which is hardware for authenticating a user, and stores user authentication information which is used to determine whether a person in question can use the apparatus 100 for encrypting a hard disk.

The host connection unit 100b is interconnected to the host terminal 200 through a cable (not shown).

The hard disk connection unit 100c is interconnected to the hard disk 300 through a cable (not shown).

The status display unit 100d indicates the operating status of the apparatus 100 for encrypting a hard disk as “Normal” or “Fault.”

Referring back to FIG. 1, the internal configuration of the apparatus 100 for encrypting a hard disk includes a host matching unit 110, a hard disk matching unit 120, an encryption processing unit 130, a control unit 140, a storage unit 150, a program management unit 160, and an IP management unit 170.

The host matching unit 110 operates in conjunction with a selective one of the interfaces of a variety of hard disks, such as a USB hard disk, a SATA hard disk and an IDE hard disk, which are additionally connected to the host terminal 200. Furthermore, the host matching unit 110 matches the host terminal 200 with the hard disk 300.

In other words, when the user transfers a data write command via the host terminal 200, the host matching unit 110 receives data, input in response to the write command, from the host terminal 200. Furthermore, the host matching unit 110 transfers the data, input in response to the write command, to the encryption processing unit 130 so that the data can be encrypted. Conversely, when the user issues a data read command via the host terminal 200, the host matching unit 110 receives decrypted data (hereinafter referred to as “decrypted data”) from the encryption processing unit 130. Moreover, the host matching unit 110 transfers the decrypted data to the host terminal 200.

The hard disk matching unit 120 operates in conjunction with a selective one of the interfaces of a variety of hard disks, such as a USB hard disk, a SATA hard disk and an IDE hard disk, which are additionally connected to the host terminal 200. Furthermore, the hard disk matching unit 120 matches the hard disk 300 with the host terminal 200.

In other words, when the user transfers a data write command via the host terminal 200, the hard disk matching unit 120 receives encrypted data (hereinafter referred to as “encrypted data”) from the encryption processing unit 130. Furthermore, the hard disk matching unit 120 transfers the encrypted data to the hard disk 300. Conversely, when the user issues a data read command via the host terminal 200, the hard disk matching unit 120 receives encrypted data stored in the hard disk 300. Moreover, the hard disk matching unit 120 transfers the encrypted data to the host terminal 200.

The encryption processing unit 130 encrypts and decrypts data using an encryption algorithm selected by the user. That is, the encryption processing unit 130 encrypts and decrypts data, transferred via the host matching unit 110, using the encryption algorithm selected by the user.

In greater detail, when the user transfers a data write command via the host terminal 200, the encryption processing unit 130 outputs a random number by applying the encryption algorithm, selected by the user, to the data transferred via the host matching unit 110. Furthermore, the encryption processing unit 130 transfers encrypted data, that is, results obtained by performing cryptographic transformation using the output random number, to the hard disk 300 via the hard disk matching unit 120.

Conversely, when the user transfers a data read command via the host terminal 200, the encryption processing unit 130 receives encrypted data from the hard disk 300. Furthermore, the encryption processing unit 130 outputs a random number by applying the encryption algorithm, selected by the user, to the encrypted data. Moreover, the encryption processing unit 130 transmits decrypted data, that is, results obtained by performing cryptographic transformation, that is, the reverse process of encryption, using the output random number, to the host terminal 200 via the host matching unit 110.

The control unit 140 controls the overall functionality of the apparatus 100 for encrypting a hard disk. In particular, when the user mounts the authentication module 400 into the authentication module connection unit 100a in order to access the apparatus 100 for encrypting a hard disk, the control unit 140 determines whether user authentication information transferred from the authentication module 400 is identical to the user authentication information previously stored in the storage unit 150. Furthermore, the control unit 140 allows data to be encrypted and decrypted only when the user authentication information transferred from the authentication module 400 is identical to the user authentication information previously stored in the storage unit 150.

The storage unit 150 stores the user authentication information stored in the authentication module 400, and stores all information used to perform encryption and decryption in the apparatus 100 for encrypting a hard disk.

The program management unit 160 manages information about programs and processes installed in the host terminal 200.

In greater detail, the program management unit 160 creates information about accessible programs and processes (hereinafter referred to as “access registration information”) by checking a list of accessible programs and processes installed in the host terminal 200. Furthermore, the program management unit 160 extracts the access registration information, and transfers and stores it to and in the storage unit 150. Furthermore, when a new program or process is executed in the host terminal 200, the program management unit 160 checks whether information about the new program or process exists in the access registration information stored in the storage unit 150. If the information about the new program or process exists in the access registration information, the program management unit 160 causes the corresponding program or process to be executed.

Meanwhile, if the information about the new program or process does not exist in the access registration information, the program management unit 160 asks the user whether to execute the new program or process. If the user approves the execution of the corresponding program or process, the program management unit 160 updates the access registration information by adding the information about the program or process to the access registration information, and then causes the corresponding program or process to be executed. If the user does not approve the execution of the corresponding program or process information, the program management unit 160 terminates the execution of the corresponding program or process information.

The IP management unit 170 manages a list of IP addresses to which data can be transferred from the host terminal 200.

In greater detail, the IP management unit 170 creates IP registration information by checking information about IP addresses which have been accessed by the programs and the processes installed in the host terminal 200. The IP management unit 170 extracts the IP registration information, and transfers and stores it to and in the storage unit 150. Furthermore, when a program or a process is connected to a network and information is transmitted from the host terminal 200 to the outside, the IP management unit 170 checks whether a destination IP address exists in the IP registration information. If the corresponding destination IP address exists, the IP management unit 170 causes data to be transmitted to the corresponding destination IP address.

Meanwhile, if the corresponding destination IP address does not exist in the IP registration information, the IP management unit 170 asks the user whether to transmit data to the corresponding destination IP address. If the user approves the transmission of the data to the corresponding destination IP address, the IP management unit 170 updates the IP registration information by adding the corresponding destination IP address to the IP registration information, and causes the data to be transmitted. If the user does not approve the transmission of the data to the corresponding destination IP address, the IP management unit 170 prevents the data from being transmitted to the corresponding destination IP address.

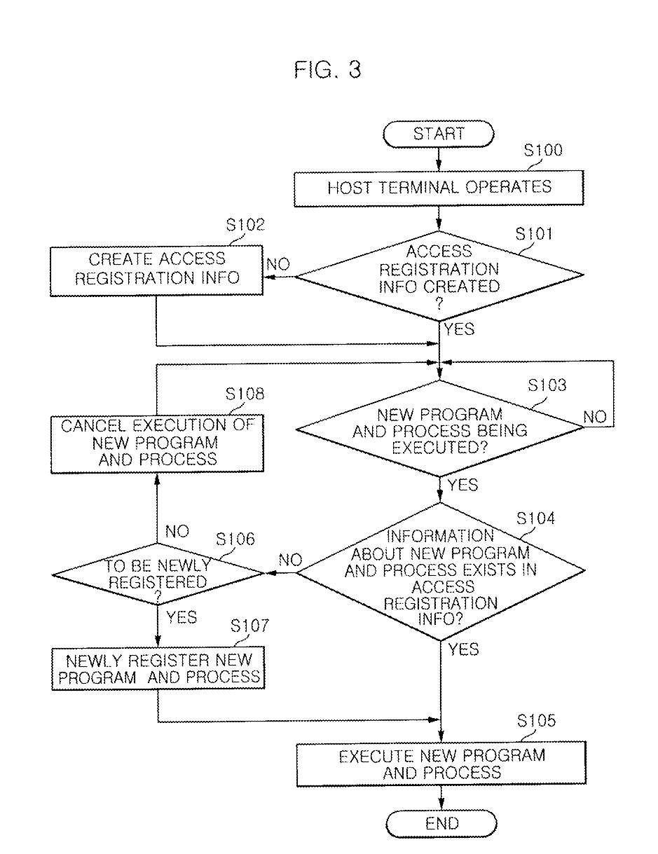

FIG. 3 is a flowchart illustrating a process in which the program management unit of the apparatus for encrypting a hard disk shown in FIG. 1 controls access so as to prevent the illegitimate leakage of data.

As shown in FIG. 3, when the host terminal 200 is booted and an Operating System (OS) is operated, the program management unit 160 of the apparatus 100 for encrypting a hard disk according to the embodiment of the present invention is executed at step S100. The program management unit 160 determines whether access registration information has been created by checking a list of programs and processes installed in the host terminal 200 at step S101.

If, as a result of the determination at step S101, it is determined that the access registration information has not been created, the program management unit 160 creates access registration information by checking a list of programs and processes currently installed in the host terminal 200 at step S102.

If, as a result of the determination at step S101, it is determined that the access registration information has been created, the program management unit 160 determines whether a new program or process is being executed at step S103.

If, as a result of the determination at step S103, it is determined that the new program or process is not being executed, the program management unit 160 continuously monitors whether a new program or process is being executed. If, as a result of the determination at step S103, the new program or process is being executed, the program management unit 160 determines whether the new program or process exists in access registration information at step S104.

If, as a result of the determination at step S104, the new program or process exists in the access registration information, the program management unit 160 causes the new program or process to be executed at step S105.

If, as a result of the determination at step S104, the new program or process does not exist in the access registration information, the program management unit 160 asks the user whether to newly register the new program or process at step S106.

If, as a result of the asking at step S106, it is determined that the user approves the new registration of the new program or process, the program management unit 160 updates the access registration information by registering the new program or process in the access registration information at step S107. Furthermore, the program management unit 160 causes the new program or process to be executed by performing step S105 in the same way.

If, as a step of the asking at step S106, the user does not approve the new registration of the new program or process, the program management unit 160 cancels the execution of the new program or process at step S108. Furthermore, the program management unit 160 returns to step S103 and determines whether a new program or process is being executed.

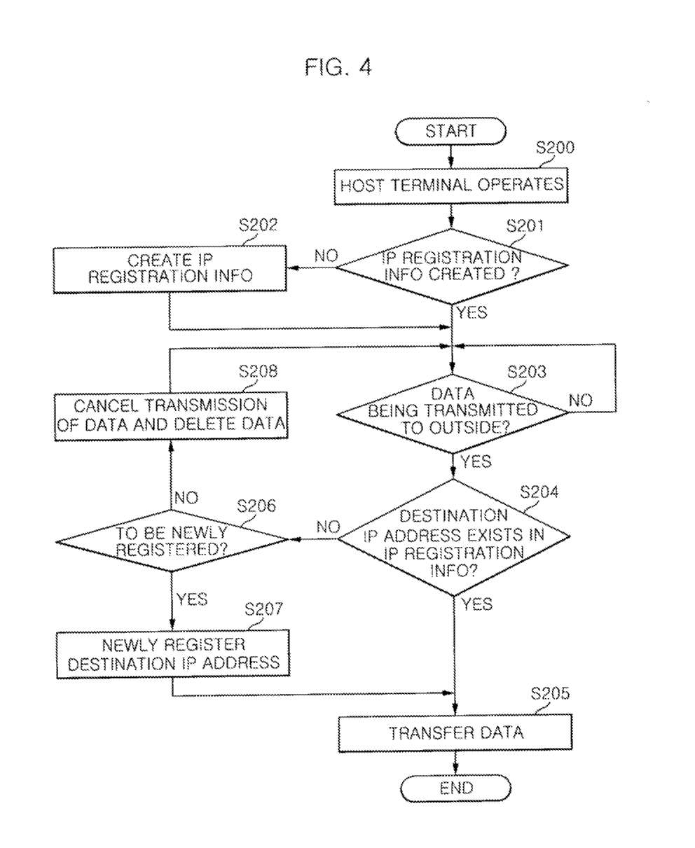

FIG. 4 is a flowchart illustrating a process in which the IP management unit of the apparatus for encrypting a hard disk shown in FIG. 1 controls access so as to prevent the illegitimate leakage of data.

As shown in FIG. 4, when the host terminal 200 is booted and the OS is operated, the IP management unit 170 of the apparatus 100 for encrypting a hard disk according to the embodiment of the present invention is executed at step S200. The IP management unit 170 determines whether IP registration information has been created by checking a list of IP addresses to which data is allowed to be transmitted from the host terminal 200 at S201.

If, as a result of the determination at step S201, the IP registration information has not been created, the IP management unit 170 creates IP registration information by checking information about IP addresses which have been accessed by programs and processes installed in the host terminal 200 at step S202.

If, as a result of the determination at step S201, it is determined that the IP registration information has been created, the IP management unit 170 determines whether data is being transmitted to the outside over a network at step S203.

If, as a result of the determination at step S203, it is determined that data is not being transmitted to the outside over a network, the IP management unit 170 continuously monitors whether data is being transmitted to the outside data over the network. If, as a result of the determination at step S203, it is determined that data is being transmitted to the outside over the network, the IP management unit 170 determines whether a destination IP address to which the data is being transmitted exists in IP registration information at step S204.

If, as a result of the determination at step S204, it is determined that the destination IP address exists in the IP registration information, the IP management unit 170 causes the data to be transmitted to the destination IP address at step S205.

If, as a result of the determination at step S204, the destination IP address does not exist in the IP registration information, the IP management unit 170 asks the user whether to newly register the destination IP address at step S206.

If, as a result of the determination at step S206, the user approves the newly registration of the destination IP address, the IP management unit 170 updates the IP registration information by registering the destination IP address in the IP registration information at step S207. Furthermore, the program management unit 160 causes the data to be transmitted to the destination IP address by performing step S205 in the same way.

If, as a result of the determination at step S206, the user does not approve the new registration of the destination IP address, the IP management unit 170 cancels the transmission of the data to the destination IP address and then deletes the corresponding data at step S208. Furthermore, the IP management unit 170 returns to step S203, and determines whether data is being transmitted to the outside over a network.

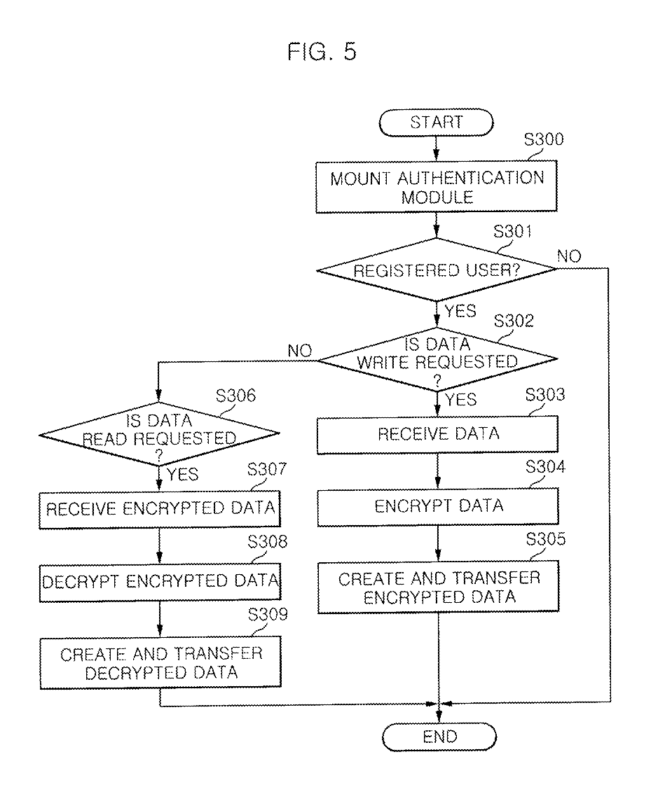

FIG. 5 is a flowchart illustrating a process in which an apparatus for encrypting a hard disk performs encryption and decryption according to the embodiment of the present invention.

As illustrated in FIG. 5, the user installs the authentication module 400 into the authentication module connection unit 100a of the apparatus 100 for encrypting a hard disk so as to access the apparatus 100 for encrypting a hard disk at step S300.

Then the control unit 140 of the apparatus 100 for encrypting a hard disk determines whether the user authentication information of the authentication module 400 is identical to user authentication information previously stored in the storage unit 150 at step S301.

If, as a result of the determination at step S301, it is determined that the user authentication information of the authentication module 400 is identical to the previously stored user authentication information, that is, that the user is a registered user, the encryption processing unit 130 determines whether the user has requested the writing of data onto the hard disk 300 at step S302.

If, as a result of the determination at step S302, the user has requested the writing of data, the encryption processing unit 130 receives data to be written onto the hard disk 300 via the host matching unit 110 at step S303. The encryption processing unit 130 creates encrypted data by encrypting the data, and transfers the created encrypted data to the hard disk 300 via the hard disk matching unit 120 at steps S304 and S305.

Meanwhile, if, as a result of the determination at step S302, the user has not requested the writing of data, the encryption processing unit 130 determines whether the user has requested the reading of the encrypted data stored in the hard disk 300 at step S306.

If, as a result of the determination at step S306, it is determined that the user has requested the reading of the stored encrypted data from the hard disk 300, the encryption processing unit 130 receives the encrypted data, stored in the hard disk 300, via the hard disk matching unit 120 at step S307. The encryption processing unit 130 creates decrypted data by decrypting the received encrypted data, and transfers the created decrypted data to the host terminal 200 via the host matching unit 110 at steps S308 and S309.

An advantage of the present invention is to provide the apparatus and method for encrypting a hard disk, which determine the accessibility of a variety of types of hard disks and perform encryption and decryption, thereby protecting the data of a user even when a hard disk is illegitimately acquired.

Another advantage of the present invention is to provide the apparatus and method for encrypting a hard disk, which, in order to prevent the leakage of data attributable illegitimate access to a hard disk, register a list of programs and processes running in a host terminal, control access, and allow only the registered programs and processes to be executed and block access to unauthorized IP addresses, thereby preventing internal information to be transmitted to the outside regardless of the user's intention.

Still another advantage of the present invention is to provide the apparatus and method for encrypting a hard disk, which encrypt and decrypt all data to be stored or mad onto or from a hard disk, so that the processing speed of encryption and decryption can be improved, thereby eliminating the inconveniences of selecting a file to be encrypted and encrypting the selected file.

Although the preferred embodiments of the present invention have been disclosed for illustrative purposes, those skilled in the art will appreciate that various modifications, additions and substitutions are possible, without departing from the scope and spirit of the invention as disclosed in the accompanying claims:

What is claimed is:

1. An apparatus for encrypting a hard disk, comprising:
a program management unit for causing an allowed program and process to be executed based on a result of determination as to whether the program and process to be executed in a host terminal is allowed to gain access;
an Internet Protocol (IP) management unit for causing data to be transmitted to an allowed destination IP address based on a result of determination as to whether the destination IP address to which the host terminal attempts to transmit the data is allowed to be accessed; and
an encryption processing unit for encrypting and decrypting all data, exchanged between the host terminal and the hard disk, by applying an algorithm, selected by a user, to the data.

2. The apparatus as set forth in claim 1, further comprising a host matching unit for operating selectively in conjunction with an interface of the hard disk *which is connected to the host terminal;
wherein the host matching unit,
when the user transfers a write command via the host terminal, transfers data, input in response to the write command, to the encryption processing unit, so that it is encrypted; and
when the user transfers a read command via the host terminal, transfers data, decrypted by the encryption processing unit, to the host terminal.

3. The apparatus as set forth in claim 2, further comprising a hard disk matching unit for operating selectively in conjunction with the interface of the hard disk which is connected to the host terminal;
the hard disk matching unit:
when the user transfers the write command via the host terminal, transferring the data, input in response to the write command and encrypted by the encryption processing unit, to the hard disk; and
when the user transfers the read command via the host terminal, receiving encrypted data stored in the hand disk and transferring the received encrypted data to the encryption processing unit.

4. The apparatus as set forth in claim 3, wherein the encryption processing unit, when the user transfers the write command via the host terminal, receives the data input in response to the write command and transferred via the host matching unit, and creates the encrypted data by applying the algorithm, selected by the user, to the input data.

5. The apparatus as set forth in claim 4, wherein the encryption processing unit transfers the encrypted data to the hard disk via the hard disk matching unit.

6. The apparatus as set forth in claim 3, wherein the encryption processing unit, when the user transfers the read command via the host terminal, receives the encrypted data transferred from the hard disk via the hard disk matching unit, and creates the decrypted data by applying an algorithm, selected by the user, to the encrypted data.

7. The apparatus as set forth in claim 6, wherein the encryption processing unit transfers the decrypted data to the host terminal via the host matching unit.

8. The apparatus as set forth in claim 1, wherein the program management unit:
creates access registration information, that is, information about accessible programs and processes, by checking a list of programs and processes installed in the host terminal; and
when a new program or process is to be executed in the host terminal, determines whether to allow it to be executed by determining whether the new program or process exists in the access registration information.

9. The apparatus as set forth in claim 1, wherein the IP management unit:
creates IP registration information by checking information about IP addresses which have been accessed by programs and processes installed in the host terminal; and
when the host terminal is connected to a program or process network and data is transferred to a destination IP address, determines whether to transmit the data by determining whether the destination IP address exists in the IP registration information.

10. A method of encrypting a hard disk comprising:
determining whether a user has mounted an authentication module into an authentication module connection unit;
determining whether user authentication information of the authentication module is identical to previously stored user authentication information;
if the user authentication information of the authentication module is identical to the previously stored user authentication information, causing an allowed program and process to be executed based on a result of determination as to whether the program and process to be executed in a host terminal is allowed to gain access;
causing data to be transmitted to an allowed destination IP address based on a result of determination as to whether the destination IP address to which the host terminal attempts to transmit the data is allowed to be accessed; and
encrypting and decrypting all data, exchanged between the host terminal and the hard disk, by applying an algorithm, selected by a user, to the data.

11. The method as set forth in claim 10, wherein the causing an allowed program and process to be executed comprises:
creating access registration information, that is, information about accessible programs and processes, by checking a list of programs and processes installed in the host terminal; and
when a new program or process is to be executed in the host terminal, determining whether to allow it to be executed by determining whether the new program or process/exists in the access registration information.

12. The method as set forth in claim 10, wherein the causing data to be transmitted to an allowed destination IP address comprises:
creating IP registration information by checking information about IP addresses which have been accessed by programs and processes installed in the host terminal; and
when the host terminal is connected to a program or process network and data is transferred to a destination IP address, determining whether to transmit the data by determining whether the destination IP address exists in the IP registration information.

13. The method as set forth in claim 10, wherein the encrypting and decrypting comprises:
when the user transfers a write command via the host terminal, receiving data input in response to the write command and transferred via a host matching unit;
creating encrypted data by applying the algorithm, selected by the user, to the input data; and
transferring the encrypted data to the hard disk via a hard disk matching unit.

14. The method as set forth in claim 10, wherein the encrypting and decrypting comprises:
when the user transfers a read command via the host terminal, receiving encrypted data from the hard disk via a hard disk matching unit;
creating decrypted data by applying the algorithm, selected by the user, to the encrypted data and
transferring the decrypted data to the host terminal via a host matching unit
